(19) United States
(12) Patent Application Publication
(10) Pub. No.: US 2023/0382616 A1
(43) Pub. Date: Nov. 30, 2023

(54) SELECTIVELY BONDED PACKAGING MATERIALS

(71) Applicant: Printpack Illinois, Inc., Elgin, IL (US)

(72) Inventor: Louis R. Duckwall, JR., Marietta, GA (US)

(21) Appl. No.: 17/237,364

(22) Filed: Apr. 22, 2021

Related U.S. Application Data
(60) Provisional application No. 63/014,190, filed on Apr. 23, 2020.

(51) Int. Cl. B65D 65/40; B32B 7/05; B32B 27/08; B32B 27/36; B32B 27/32

(52) U.S. Cl. CPC B65D 65/40; B32B 7/05; B32B 27/08; B32B 27/36; B32B 27/32; B32B 2553/00

(57) ABSTRACT

A flexible packaging material includes first and second polymeric films, selectively bonded areas between and joining the first and second polymeric films to one another, and selectively unbonded areas between the first and second polymeric films. At least portions of the first and second polymeric films are in opposing face-to-face contact with one another in at least some of the unbonded areas. At least some of the bonds are respectively positioned between at least some of the unbonded areas.

### CROSS-REFERENCE TO PRIORITY APPLICATION

This application claims the benefit of U.S. Provisional Patent Application No. 63/014,190 filed Apr. 23, 2020, which is hereby incorporated by reference in its entirety.

### BACKGROUND

The present disclosure is directed generally to a material for forming packages (i.e., a packaging material). As a more specific example, the present disclosure is directed generally to a flexible packaging material that includes bonded-together polymeric layers, and that optionally may be formed into a package for containing and dispensing liquid.

It is typical for adjacent polymeric layers of flexible packaging material to be joined to one another by a bond extending continuously across the entire length and width of the packaging material. When such packaging material is formed into a package for containing and dispensing liquid, and the package is shaken continually to keep the liquid contents properly mixed, the package may be subject to flexural failure after prolonged shaking. “Flexural failure” may generally refer to the formation of cracks, pinholes, or the like in the packaging material (or package) caused by repeatedly flexing or moving the packaging material (or package) during shaking of the package to keep liquid contents mixed.

There is a desire for a packaging material that provides, for example, a reduction in flexural failure and/or other advantages.

### SUMMARY

An aspect of this disclosure is the provision of a material that may be used for forming packages (e.g., a packaging material), wherein the material includes a plurality of layers joined to one another in a manner that increases the flexibility of the material and minimizes the flexural failure of the material over time. “Flexural failure” can generally refer to the formation of cracks, pinholes, or the like in the packaging material (or package) caused by repeatedly flexing or moving the packaging material (or package).

The present packaging materials may find use in a variety of applications. For example, packages for containing liquids are often formed from relatively thick films. These packages typically need to be agitated or shaken to ensure that their contents are evenly mixed. In some cases, the repeated bending and flexing of the package in response to the external movement of the package and the internal movement of the contents, such as during continual “shaking,” may cause the package to be fail at one or more flexure points.

The packaging material described herein includes selective, or partial, bonding (e.g., unbonded areas) between at least two adjacent layers. As a more specific example, the flexible packaging material can include both selectively bonded and selectively unbonded polymeric layers. The selective bonding (e.g., the inclusion of predetermined unbonded areas) can increase the flexibility of the packaging material, so that packages formed therefrom are typically capable of withstanding repeated flexing substantially without flexural failure.

The foregoing summary provides a few brief examples and is not exhaustive, and the present invention is not limited to the foregoing examples. Various other features, aspects, and advantages of the present invention will be evident from the following description and accompanying drawings.

### BRIEF DESCRIPTION OF THE DRAWINGS

The drawings are provided as examples, and the drawings are schematic and may not be drawn to scale. The present invention may be embodied in many different forms and should not be construed as limited to the examples depicted in the drawings.

FIG. 1A is a cross-sectional view of a representative portion of composite structure that may be used as a packaging material, wherein the cross section is taken along line 1A-1A of FIG. 1B, in accordance with a first embodiment of this disclosure.

FIG. 1B is a top and/or bottom plan view of the composite structure or packaging material of FIG. 1A, wherein a pattern of bonds between interior polymeric layers of the packaging material is schematically depicted with dashed lines, in accordance with the first embodiment.

FIG. 2A is a more detailed cross-sectional view of the packaging material of the first embodiment and/or FIG. 2A can be considered to disclose a composite structure or packaging material in accordance with a second embodiment of this disclosure.

FIG. 2B is a cross-sectional view like FIG. 2A, except that FIG. 2B is less schematic than FIG. 2A with regard to, for example, the depiction of bonded and unbonded areas between several layers of the packaging material.

FIG. 3 depicts a laminating system that can be used for forming the packaging material, and FIG. 3 also depicts a packaging system that can be used for forming packages comprising the packaging material, in accordance with the first and second embodiments of this disclosure.

FIG. 4 depicts an example of a package comprising the packaging material, in accordance with the first and second embodiments of this disclosure.

FIG. 5 is a cross-sectional view taken along line 5-5 of FIG. 4.

### DETAILED DESCRIPTION

Examples of embodiments are disclosed in the following. The present invention may, however, be embodied in many different forms and should not be construed as limited to the embodiments set forth herein. For example, features disclosed as part of one embodiment or example can be used in the context of another embodiment or example to yield a further embodiment or example. As another example of the breadth of this disclosure, it is within the scope of this disclosure for one or more of the terms “substantially,” “about,” “approximately,” and/or the like, to qualify each of the adjectives and adverbs of the Detailed Description section of disclosure, as discussed further below.

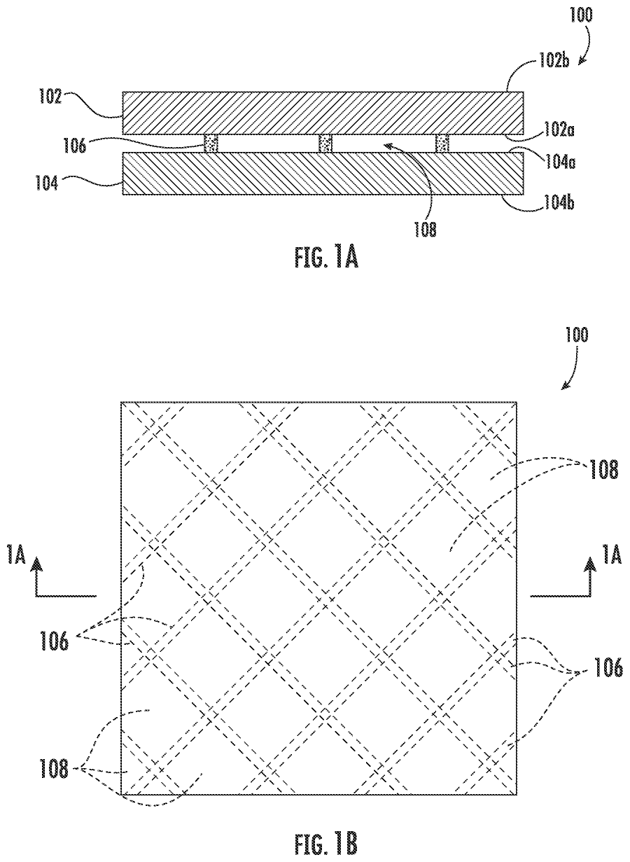

FIGS. 1A and 1B schematically depict an exemplary packaging material/composite structure 100. As shown in the cross section depicted in FIG. 1A, the packaging material 100 may generally include a plurality of layers in a superposed, facing, contacting relationship with one another. The layers may be continuous or discontinuous, as will be understood by those skilled in the art.

More particularly, in the example depicted in FIG. 1A, the material 100 includes a first layer or layer portion 102 (or first portion 102) having an inner surface 102a and an outer surface 102b, and a second layer or layer portion 104 (or second portion 104) having an inner surface 104a and an outer surface 104b. The first portion 102 and the second portion 104 may each include a plurality of layers, as will be described further below. When the material 100 is used as a packaging material, the outer surface 104b can extend at least partially around and at least partially define (e.g., be in opposing face-to-face relation with) an interior space of a package (e.g., container) formed from the material 100, wherein the interior space is configured for containing contents of the package, as discussed further below.

The respective inner surfaces 102a, 104a of the first layer portion 102 and the second layer portion 104 are joined to one another at or along bonded areas 106 by bonds (e.g., adhesive sealing and/or bonding, heat fusion sealing and/or bonding, heat-sealed seals, and/or other suitable sealing and/or bonding). Unbonded areas 108 are disposed between the bonded areas or bonds 106. Typically the unbonded areas 108 (e.g., any voids defined by the unbonded areas 108) do not contain air or other fluid (e.g., substantially do not contain air or other fluid). Whereas FIG. 1A schematically depicts the unbonded areas 108 in the form of cavities, pockets, or chambers for ease of understanding, typically any cavities, pockets, or chambers defined by the unbonded areas are minimal in size and typically do not contain air or other fluid (e.g., substantially do not contain air or other fluid). For example, the bonded and unbonded areas 106, 108 can be coplanar or about coplanar (e.g., substantially coplanar) with one another.

While not wishing to be bound by theory, regarding a package formed from the material 100, it is believed that by only partially bonding the first portion 102 to the second portion 104 of the material 100, the material 100 is better able to flex repeatedly to allow for mixing of the contents of the package substantially without forming a stress point, which might otherwise lead to the formation of a pinhole or crack in the material. Instead, the two portions 102, 104 of the material 100 are able to move about the bonded areas 106 and unbonded areas 108 in a manner that imparts greater flexibility to the overall structure.

In the example depicted in FIG. 1A, for each of the unbonded areas 108, the portions of the inner surfaces 102a, 104a that at least partially define the unbonded area are in unbonded opposing face-to-face relation with one another, and more specifically at least some of those portions, a majority of those portions, or substantially all of those portions may be in unbonded opposing face-to-face contact with one another. In this regard, FIG. 1A is schematic and/or not drawn to scale because, for example, for each of the unbonded areas 108, FIG. 1A depicts a relatively large gap between the portions of the inner surfaces 102a, 104a that at least partially define the unbonded area. In contrast, those gaps may be relatively smaller or substantially nonexistent. At least some of, a majority of, or substantially all of the portions of the inner surfaces 102a, 104a that define the unbonded areas 108 can be in unbonded opposing face-to-face contact with one another. In contrast, FIG. 1A is schematic and/or not drawn to scale because the heights of the bonds 106 and unbonded areas 108 are exaggerated for ease of understanding. As another example of FIG. 1A being schematic, depth-wise portions of the material 100 are not depicted in FIG. 1A (e.g., only the cross-sectional plane is depicted).

In FIG. 1B, the bonds or bonded areas 106 are schematically depicted with dashed lines because they may be substantially hidden from view as a result of being defined between interior polymeric layers of the material 100, as discussed further below. In contrast, the bonds or bonded areas 106, or features associated therewith, may be visible to the naked eye at one or both of the outer surface 102b, 104b (FIG. 1A) of the material 100. FIG. 1B can be illustrative of both top and bottom plan views of the material 100. In the example depicted in FIG. 1B, numerous of the unbonded areas 108 are fully circumscribed by respective bonds 106. In embodiments of this disclosure, each of the fully circumscribed unbonded areas 108 can be substantially void of air or any other contents (e.g., not filled with fluid). Each of the fully circumscribed unbonded areas 108 can lack any openings configured for providing access to any interior space defined by the unbonded area.

In the example depicted in FIG. 1B, the patterned bond areas 106 may be configured as bond lines in a cross hatch pattern (e.g., crosswise or perpendicularly intersecting lines), such that the unbonded areas or spaces 108 between the bonded areas 106 are generally square shaped (or rectangular or diamond shaped). For example, at least some of, a majority of, or each of the bond lines 106 can be about one eighth of an inch wide, and adjacent bond lines extending in the same direction (e.g., parallel to one another) can be spaced apart from one another by about one inch. As an example, some of the bond lines 106 extending in the same direction can be referred to as a first plurality of seals, and other of the bond lines extending in the same direction can be referred to as a second plurality of seals, and the second plurality of seals can extend crosswise (e.g., perpendicularly) to the first plurality of seals, to at least partially define a rectangular pattern. The pattern can be repeated continuously along the length and/or width of the material 100. However, countless other suitable patterns can be used, and the patterns may vary along the length and/or width of the material 100. By way of example, and not limitation, the bonded areas 106 may be singular and/or overlapping dots, lines, waves, circles, and/or any other regular or irregular shape or pattern.

As best understood with reference to FIG. 1B, a degree of bonding between the inner surfaces 102a, 104a may be calculated for a flat piece of the material 100 by dividing the total area of the bonds 106 (in a plan view) by the overall area of the flat piece of material (in the plan view). In this regard and in some embodiments, the degree of bonding (i.e., percent bond area) may be at least about 5%, at least about 10%, at least about 15%, at least about 20%, at least about 25%, at least about 30%, at least about 35%, at least about 40%, at least about 45%, at least about 50%, at least about 60%, at least about 65%, at least about 70%, or at least about 75%. Similarly, a percent of unbonded area between the inner surfaces 102a, 104a may be calculated for a the flat piece of the material 100 by dividing the total area of the unbonded areas 108 (in a plan view) by the overall area of the flat piece of material (in the plan view). The percent unbonded area may be at least about 25%, at least about 30%, at least about 35%, at least about 40%, at least about 45%, at least about 50%, at least about 60%, at least about 65%, at least about 70%, at least about 75%, at least about 80%, at least about 85%, at least about 90%, or up to about 95%.

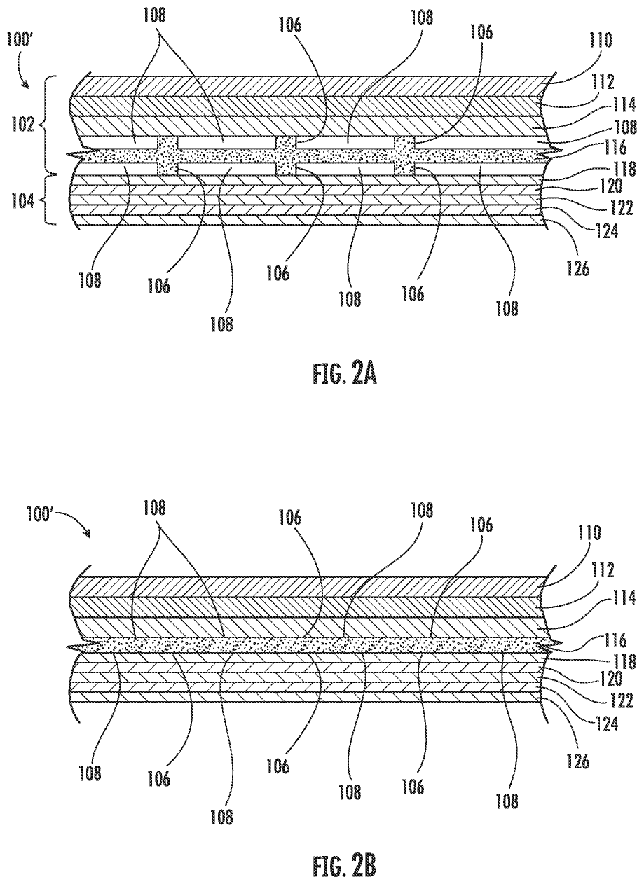

FIG. 2A schematically depicts one particular example of a packaging material 100′ that may be suitable for use with the present disclosure. In the depicted example, the first portion 102 of the material includes a polyester film layer 110 (e.g., an aluminum oxide coated polyethylene terephthalate film layer having a thickness of from about 32 gauge to about 92 gauge, for example, about 48 gauge), a polyethylene extrudate layer 112 (e.g., having a coat weight of from about 5 lb/ream to about 15 lb/ream, for example, about 9 lb/ream, and a thickness of from about 30 gauge to about 100 gauge, for example, about 60 gauge), and a nylon film layer 114 (e.g., a biaxially oriented nylon film having a thickness of from about 40 gauge to about 100 gauge, for example, about 60 gauge). Other layers may be included, and some may be omitted.

The first portion 102 may also include, or have associated therewith, a layer of polyethylene extrudate 116 (e.g., having a coat weight of from about 5 lb/ream to about 15 lb/ream, for example, about 10 lb/ream, and a thickness of from about 30 gauge to about 100 gauge, for example, about 70 gauge). As best understood with reference to FIG. 2A, some of (e.g., some of the upper surface of) the polyethylene layer 116 can be joined (e.g., bonded) to the nylon layer 114 to define upper bonded areas 106 and upper unbonded areas 108, and some of (e.g., some of the lower surface of) the polyethylene layer 116 can be joined (e.g., bonded) to the second portion 104 of the material 100′ to define lower bonded areas 106 and lower unbonded areas 108. The “heights” of the unbonded areas 108 are exaggerated in FIG. 2A, as discussed further below. Typically the upper and lower unbonded areas 108 (e.g., any relatively small voids defined by the unbonded areas 108) do not contain any air or other fluid (e.g., substantially do not contain any air or other fluid). The upper and lower bonded areas 106 can be respectively superposed with one another, and the upper and lower unbonded areas 108 can be respectively superposed with one another,

The second portion 104 of the material 100′ may include a plurality of coextruded layers, for example, a polyolefin film layer 118 (e.g., linear low density polyethylene (LLDPE)), a nylon layer 120, an ethylene vinyl alcohol (EVOH) layer 122, a nylon layer 124, and a metallocene polyethylene sealant layer 126. Other layers may be included, and some may be omitted. The second portion 104 of the material 100′ may have a thickness of about 350 gauge to about 450 gauge, for example, about 400 gauge.

At least partially reiterating from above, it is believed that by only partially (i.e., selectively) joining respective layers of the first and second composite layers 102, 104 of the material 100′ to one another (e.g., to define the bonded and unbonded areas 106, 108), the material 100′ may be more flexible, and therefore, may be more able to undergo repeated stresses to allow for mixing of the contents of the package without being prone to flexural failure. In contrast, a packaging material in which the bonded areas 106 are replaced with a continuous layer of bonding (i.e., a fully joined/sealed layer of polyethylene 116) may experience such flexural failures due to the overall increased rigidity of the packaging material structure.

In the example depicted in FIG. 2A, for each of the upper unbonded areas 108, respective portions of the nylon layer 114 and the polyethylene layer 116 that at least partially define the upper unbonded areas are in unbonded opposing face-to-face relation with one another, and more specifically at least some of those portions, a majority of those portions, or substantially all of those portions may be in unbonded opposing face-to-face contact with one another, as discussed further below. Similarly, for each of the lower unbonded areas 108, respective portions of the LLDPE layer 118 and the polyethylene layer 116 that at least partially define the lower unbonded areas are in unbonded opposing face-to-face relation with one another, and more specifically at least some of those portions, a majority of those portions, or substantially all of those portions may be in unbonded opposing face-to-face contact with one another, as discussed further below. In the example depicted in FIG. 2A, for the upper bonded and unbonded areas 106, 108, and similarly for the lower bonded and unbonded areas 106, 108, the percent of bonded and unbonded areas can be as discussed above with reference to FIG. 1B.

FIG. 2A is schematic and/or not drawn to scale because, for example, the heights of the bonds 106 and unbonded areas 108 are exaggerated for ease of understanding. As a more specific example, for each of the unbonded areas 108, FIG. 2A schematically depicts a relatively large gap between the respective surfaces that at least partially define the unbonded area. In contrast, those gaps may be relatively smaller or substantially nonexistent. As another example of FIG. 2A being schematic, depth-wise portions of the material 100′ are not depicted in FIG. 2A.

FIG. 2B is cross-sectional view like FIG. 2A, except that FIG. 2B is less schematic than FIG. 2A with regard to the bonded and unbonded areas 106, 108. For example, FIG. 2B schematically depicts that each of the opposite upper and lower surfaces of the polyethylene layer 116 can be about planer (e.g., substantially planer). For at least some of, a majority of, or each of the upper unbonded areas 108, at least a portion of, a majority of, or all of the respective portions of the nylon layer 114 (e.g., the upwardly adjacent layer) and the polyethylene layer 116 (e.g., the intermediate layer) that define the upper unbonded area can be in unbonded opposing face-to-face contact with one another. Similarly, for at least some of, a majority of, or each of the lower unbonded areas 108, at least a portion of, a majority of, or all of respective portions of the LLDPE layer 118 (e.g., lower adjacent layer) and the polyethylene layer 116 (e.g., the intermediate layer) that define the lower unbonded area can be in unbonded opposing face-to-face contact with one another. For at least about 25%, 35%, 50%, 65%, 75%, 90%, 95%, 98%, or 100% of the unbonded areas 108, at least about 25%, 35%, 50%, 65%, 75%, 90%, 95%, 98%, or 100% of the opposite surfaces that define the unbonded area can be in opposing face-to-face contact with one another. For example, the unbonded areas 108 are typically not (e.g., substantially not) filled or inflated with air or other fluid(s).

In the example depicted in FIG. 2B, for the upper bonded and unbonded areas 106, 108, and similarly for the lower bonded and unbonded areas 106, 108, the percent of bonded and unbonded areas can be as discussed above. As a more specific example using the frame of reference depicted in FIG. 2B, at the interface between the lower surface of the nylon layer 114 (e.g., first layer) and the upper surface of the polyethylene layer 116 (e.g., second layer), and/or at the interface between the upper surface of the LLDPE layer 118 (e.g., third layer) and the lower surface of the polyethylene layer 116: the degree of bonding (i.e., percent bond area) may be at least about 5%, at least about 10%, at least about 15%, at least about 20%, at least about 25%, at least about 30%, at least about 35%, at least about 40%, at least about 45%, at least about 50%, at least about 60%, at least about 65%, at least about 70%, or at least about 75%; and/or the percent unbonded area may be at least about 25%, at least about 30%, at least about 35%, at least about 40%, at least about 45%, at least about 50%, at least about 60%, at least about 65%, at least about 70%, at least about 75%, at least about 80%, at least about 85%, at least about 90%, or up to about 95%. The embodiments depicted in FIGS. 1A and 2B can be alike, except for variations noted and variations that will be apparent to those of ordinary skill in the art.

Aspects of an example of a method of manufacturing the materials 100, 100′ are described in the following, with reference to FIG. 3. The manufacturing of the packaging materials 100, 100′ can at least partially occur in a lamination system 200 configured to laminate a first web to the second web 104. The first web can include, for example, the previously joined together polyester, polyethylene, and nylon layers 110, 112, 114 (also see, e.g., FIG. 2B), such that the first web can collectively be designated by the numerals 110, 112, 114. The first web 110, 112, 114 and second web 104 can be laminated to one another through the use of an adhesive material (e.g., melted thermoplastic polymeric material) that can be a precursor of the solidified polyethylene layer 116 (see, e.g., FIG. 2B). Accordingly, in FIG. 3, an extruded, melted thermoplastic polymeric material (e.g., polyethylene) is designated by numeral 116. The extrudate 116 can be extruded by a conventional extruder through a conventional extrusion die.

A pair of rollers 202, 204 (e.g., motor-driven roller(s)) can form a nip toward which the first web 110, 112, 114 and second web 104 are drawn, and in which the first and second webs and melted polyethylene 116 are received as part of the laminating process. Outwardly protruding portions, ridges, or protrusions 206 of the patterned sealing roller 202 (e.g., sealing member) can be arranged in a pattern corresponding to the bonded areas 106 (see, e.g., FIG. 1B) so that pressure is indirectly applied to the extrusion-melted polyethylene 116, so that when the extruded polyethylene 116 cools it at least partially defines the above-discussed bonded and unbonded areas 106, 108. In the embodiment depicted in FIG. 3, the bonding associated with the forming of the seals or bonds 106 includes engaging the sealing member(s) 202, 206 against the outer surface of the polyester layer 110 (e.g., outer layer) so that the bonds or seals 106 are formed at least partially in response to force being transferred from the protrusions 206 to and through the first web 110, 112, 114 to the polyethylene layer 116 in a predetermined pattern, so that the unbonded areas 108 are typically provided without being filled by air or any other fluid (e.g., substantially do not contain air or other fluid). The counter roller 204 may be cooled and have a smooth exterior (e.g., a water-cooled chrome roll). The exterior material of the sealing roller 202 can be rubber or another suitable material. The protrusions 206 can be formed by reducing the thickness of the exterior material that is adjacent the protrusions 206 by way of engraving (e.g., laser engraving). Any other suitably configured sealing members (e.g., plates, rollers, or the like, with protrusions 206, or the like) and associated counter-plates, counter-rolls, or the like, may be used to form the pattern of bonded and unbonded areas 106, 108.

Downstream of the lamination apparatus 200, the material 100, 100′ (e.g., typically after being formed into a roll and then being unrolled) may be supplied to a conventional system 210 for at least partially forming packages 300 (e.g., bags or other suitable containers) from the material. The conventional package-forming or packaging system 210 can include, for example, conventional folding and sealing stations 212, 214, and other suitable conventional stations, configured to serially form, and optionally also fill, the packages 300.

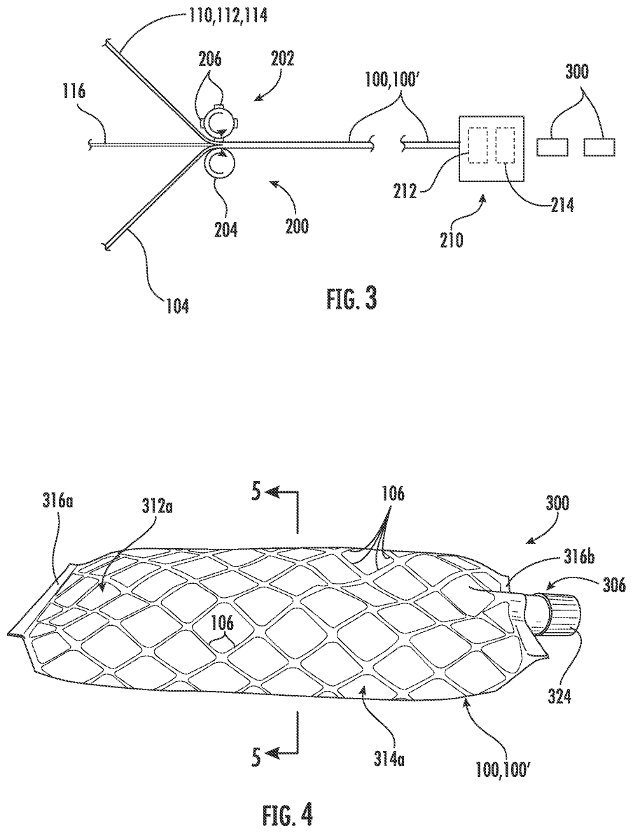

In some embodiments, a package 300 may be made only partially from the material or composite 100, 100′, while in other embodiments, the package may be made mostly or entirely from the material or composite 100, 100′. By way of example, and not limitation, FIG. 4 schematically depicts an example of a typical package 300 that can be formed from the material 100, 100′ and can include a dispensing fitment 306 or other suitable feature for providing access to the interior of the package. In the example depicted in FIG. 4, the bonds or bonded areas 106, may be visible to the naked eye at the exterior of the package 300 as a result of the layers 110, 112, 114 being at least partially transparent; and/or other features (e.g., indentations formed by the patterned roller 202) associated with the bonded areas 106 may be visible to the naked eye, wherein these features may be designated by numeral 106 in FIG. 4.

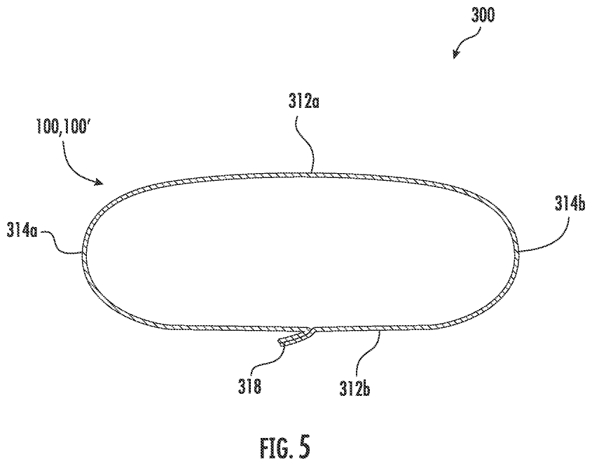

FIG. 5 is a schematic cross-sectional view of the package 300, wherein the contents and depth-wise portions of the package are not depicted in FIG. 5. Referring to FIGS. 4 and 5, the package 300 can include at least one sidewall extending around an interior of the package, wherein the at least one sidewall typically includes opposite top and bottom wall portions or faces 312a, 312b, and opposite side portions or faces 314a, 314b. The package 300 typically includes closure seals, for example opposite end seals 316a, 316b (e.g., end closure seals), and a lengthwise fin seal 318 (e.g., side closure seal).

In another example not depicted in the drawings, the opposite side portions 314a, 314b can be in the form of side gussets. The gussets can be at least partially provided by the package 300 further including lengthwise pairs of pleat portions that are sealed together by lengthwise seals that may be referred to as pleat seals. There can be four of such pleat seals located at lengthwise corners of the package 300, and the fin seal 318 may take the place of one of the pleat seals, or the like. A wide variety of differently configured packages and seals are within the scope of this disclosure.

Each of the seals 316, 318 can be a heat-sealed seal comprising respective portions of the sealant layer 126 (see. e.g., FIG. 2B) that are in opposing face-to-face contact with one another and that have been forced together and brought to a sufficient temperature (e.g., to or above their seal initiation temperature) to form the seal. As a more specific example, at an intermediate portion of the end seal 316b, the respective portions of the sealant layer 126 can be sealed against a base of the conventional fitment 306. The fitment 306 can include a conduit extending outwardly from the fitment base, and a removable cap 324 can be mounted to the outer end portion of the conduit for opening and closing access to the interior of the package 300. External threads of the conduit can mate with internal threads of the cap 324 for providing the openable, leak-proof connection therebetween. As examples, the fitment 306 can include a valve (e.g., a one-way valve), the cap 324 and/or fitment can be replaced with a conventional spigot having a valve actuated by a handle or lever, or access to the contents in the interior of the package 300 may be provided in any other suitable manner.

Depending on the particular application, it may be determined that particular contents and/or usages may cause particular stresses on the package 300, which could otherwise lead to pinholes or other flexural failures. For example, in some applications, it may be determined that the gusset panels 314a, 314b are exposed to particular stresses, for example, where the contents need to be continuously shaken or mixed, and therefore, may be prone to flexural failures. Accordingly, in such packaging applications, at least the package gussets may be formed from the present composite material 100, 100′. Alternatively, in other embodiments, other portions of the package, such as the opposite walls or faces 312a, 312b along the top end or bottom end of the package 300 may be prone to stresses, and therefore, the front and/or back panel may be formed from the present material 100, 100′ to facilitate alleviating such stresses, and ultimately, material failure. In still other examples, such as shown in FIG. 4, substantially all of the package 300 may be formed from the material 100, 100′. By allowing at least portions of at least some of the layers of the packaging material 100, 100′ to flex individually with respect to one another, failure-causing stress can be at least significantly reduced in a manner that seeks to avoid failures of the packaging material.

### EXAMPLE

Packaging materials as described in Table 1 were used to form packages generally similar to those shown in FIGS. 4 and 5 (except, e.g., the opposite side portions 314a, 314b were in the form of side gussets). Forty packages formed from the control material and forty packages formed from the experimental material were then subjected to agitation (e.g., shaking) testing. Each package was filled with about 500 ml of water and placed in an agitation tower where the package was shaken for ten days, during which the package was subject to about four million agitation (or shaking) cycles. After testing, each package was inspected for pinholes, cracks, or other flexural failure. The results are presented in Table 1. The experimental packages exhibited no flexural failures, compared with the control packages, which exhibited thirteen flexural failures. Accordingly, the partial bonding of the experimental packaging material provided the needed material flexibility to allow the package contents to be mixed (e.g., the packages to be shaken) without causing flexural failure.

TABLE 1

| Control | Experimental |
|---|---|
| Structure: | Structure: |
| ~40 ga aluminum oxide coated PET | ~40 ga aluminum oxide coated PET |
| ~9 lb/ream polyethylene | ~9 lb/ream polyethylene |
| ~60 ga biaxially oriented nylon | ~60 ga biaxially oriented nylon |
| ~10 lb/ream polyethylene | ~10 lb/ream polyethylene |
| ~400 ga multilayer coextrusion of | ~400 ga multilayer coextrusion of |
| LLDPE/nylon/EVOH/nylon/mPE sealant, | LLDPE/nylon/EVOH/nylon/mPE sealant, |
| where the ~10 lb/ream polyethylene was fully | where the ~10 lb/ream polyethylene was |
| sealed/bonded to the ~400 ga multilayer | bonded to the ~400 ga multilayer coextrusion |
| coextrusion | using a cross hatch pattern with ~⅛″ wide |
| | bond lines spaced ~1″ apart (see, e.g., FIG. 4) |
| Results: After four million cycles of agitation/ | Results: After four million cycles of agitation/ |
| shaking, 13 of 40 packages exhibited flexural | shaking, 0 of 40 packages exhibited flexural |
| failure | failure |

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” and the like. For example, variations may occur as manufacturing components wear and/or are replaced, or the like. Those of ordinary skill in the art will understand that, in manufacturing processes, typically there are engineering tolerances comprising permissible limits in variations of dimensions, and the tolerances can vary in different circumstances. Accordingly, it is believed that those of ordinary skill will readily understand usage herein of the terms such as “substantially,” “about,” “approximately,” and/or the like.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

In the specification and drawings, examples of embodiments have been disclosed. The present invention is not limited to such exemplary embodiments. The use of the term “and/or” includes any and all combinations of one or more of the associated listed items. Unless otherwise noted, specific terms have been used in a generic and descriptive sense and not for purposes of limitation.

1. A flexible packaging material comprising:
a plurality of layers comprising first and second polymeric films;
a plurality of bonds between and joining the first and second polymeric films to one another;
a plurality of unbonded areas between the first and second polymeric films; and
a pattern, wherein the pattern comprises the plurality of bonds and the plurality of unbonded areas, and the pattern is repeated along a length and/or width of the flexible packaging material,
wherein the first and second polymeric films are at least in opposing face-to-face relation with one another in unbonded areas of the plurality of unbonded areas,
wherein in at least some of the unbonded areas of the plurality of unbonded areas, at least some of respective portions of the first and second polymeric films are in opposing face-to-face contact with one another, and
wherein bonds of the plurality of bonds are respectively positioned between unbonded areas of the plurality of unbonded areas.

2. The flexible packaging material according to claim 1, wherein in each of the unbonded areas of the plurality of unbonded areas, the first and second polymeric films are in opposing face-to-face contact with one another.

3. The flexible packaging material according to claim 1, wherein:
the second polymeric film has opposite first and second surfaces;
the first surface of the second polymeric film is at least in opposing face-to-face relation with the first polymeric film;
the plurality of bonds and plurality of unbonded areas are cooperatively configured so that:
at least about 5% of the first surface of the second polymeric film is bonded to the first polymeric film, and
at least about 25% of the first surface of the second polymeric film is not bonded to the first polymeric film.

4. The flexible packaging material according to claim 1, wherein:
the second polymeric film has opposite first and second surfaces;
the first surface of the second polymeric film is at least in opposing face-to-face relation with the first polymeric film;
the plurality of bonds and plurality of unbonded areas are cooperatively configured so that:
at least about 15% of the first surface of the second polymeric film is bonded to the first polymeric film, and
at least about 50% of the first surface of the second polymeric film is not bonded to the first polymeric film.

5. (canceled)

6. The flexible packaging material according to claim 1, wherein the second polymeric film is an extruded, thermoplastic polymeric film.

7. The flexible packaging material according to claim 1, wherein:
the plurality of layers comprises a third polymeric film;
the second polymeric film is positioned between the first and third polymeric films; and
at least portions of the second and third polymeric films are at least in opposing face-to-contact with one another and bonded to one another.

8. The flexible packaging material according to claim 1, wherein:
the plurality of bonds is a first plurality of bonds;
the plurality of unbonded areas is a first plurality of unbonded areas;
the plurality of layers comprises a third polymeric film;
the second polymeric film is positioned between the first and third polymeric films; and
the flexible packaging material comprises:
a second plurality of bonds between and joining the second and third polymeric films to one another, and
a second plurality of unbonded areas between the second and third polymeric films,
the second and third polymeric films are at least in opposing face-to-face relation with one another in unbonded areas of the second plurality of unbonded areas,
in at least some of the unbonded areas of the second plurality of unbonded areas, at least some of respective portions of the second and third polymeric films are in opposing face-to-face contact with one another; and
bonds of the second plurality of bonds are respectively positioned between unbonded areas of the second plurality of unbonded areas.

9. The flexible packaging material according to claim 1, wherein the first and second polymeric films are positioned between opposite outer layers of the plurality of layers.

10. (canceled)

11. The flexible packaging material according to claim 1, wherein the plurality of bonds comprises a plurality of seals extending along a length of the flexible packaging material.

12. The flexible packaging material according to claim 11, wherein:
the plurality of seals is a first plurality of seals; and
the plurality of bonds comprises a second plurality of seals extending crosswise to the first plurality of seals.

13. The flexible packaging material according to claim 12, wherein the first and second pluralities of seals at least partially define a rectangular pattern.

14. A package comprising:
at least one piece of packaging material extending around an interior space of the package, wherein the at least one piece of packaging material comprises:
a plurality of layers comprising first and second polymeric films,
a plurality of bonds between and joining the first and second polymeric films to one another,
a plurality of unbonded areas between the first and second polymeric films, and
a pattern, wherein the pattern comprises the plurality of bonds and the plurality of unbonded areas, and the pattern is repeated along a length and/or width of the packaging material,
wherein the first and second polymeric films are at least in opposing face-to-face relation with one another in unbonded areas of the plurality of unbonded areas, wherein in at least some of the unbonded areas of the plurality of unbonded areas, at least some of respective portions of the first and second polymeric films are in opposing face-to-face contact with one another, and wherein bonds of the plurality of bonds are respectively positioned between unbonded areas of the plurality of unbonded areas; and
a closure seal connecting first and second portions of the at least one piece of packaging material to one another so that the closure seal at least partially closes the interior space.

15. The package according to claim 14, wherein:
the second polymeric film has opposite first and second surfaces;
the first surface of the second polymeric film is at least in opposing face-to-face relation with the first polymeric film;
the plurality of bonds and plurality of unbonded areas are cooperatively configured so that:
at least about 5% of the first surface of the second polymeric film is bonded to the first polymeric film, and
at least about 25% of the first surface of the second polymeric film is not bonded to the first polymeric film.

16. The package according to claim 14, wherein:
the second polymeric film has opposite first and second surfaces;
the first surface of the second polymeric film is at least in opposing face-to-face relation with the first polymeric film;
the plurality of bonds and plurality of unbonded areas are cooperatively configured so that:
at least about 15% of the first surface of the second polymeric film is bonded to the first polymeric film, and
at least about 50% of the first surface of the second polymeric film is not bonded to the first polymeric film.

17. The package according to claim 14, wherein:
the plurality of bonds is a first plurality of bonds;
the plurality of unbonded areas is a first plurality of unbonded areas;
the plurality of layers comprises a third polymeric film;
the second polymeric film is positioned between the first and third polymeric films; and
the package comprises:
a second plurality of bonds between and joining the second and third polymeric films to one another, and
a second plurality of unbonded areas between the second and third polymeric films,
the second and third polymeric films are at least in opposing face-to-face relation with one another in unbonded areas of the second plurality of unbonded areas; and
bonds of the second plurality of bonds are respectively positioned between unbonded areas of the second plurality of unbonded areas.

18. The package according to claim 14, wherein:
the first and second polymeric films are positioned between opposite outer and inner layers of the plurality of layers; and
the inner layer is a polymeric layer that at least partially forms a heat-sealed closure seal in the package.

19-20. (canceled)

21. The flexible packaging material according to claim 1, comprising an extrudate layer positioned between the first and second polymeric films, wherein portions of the extrudate layer forms bonds of the plurality of bonds between and joining the first and second polymeric films.

22. The flexible packaging material according to claim 21, comprising:
portions of a first surface of the extrudate layer bonded to the first polymeric film to define a first plurality of bonds between and joining the first surface of the extrudate layer and the first polymeric film, and
portions of a second opposing surface of the extrudate layer bonded to the second polymeric film to define a second plurality of bonds between and joining the second opposing surface of the extrudate layer and the second polymeric film.

23. The package according to claim 14, comprising an extrudate layer positioned between the first and second polymeric films, wherein portions of the extrudate layer forms bonds of the plurality of bonds between and joining the first and second polymeric films.

24. The flexible packaging material according to claim 1, wherein the pattern is repeated along the length of the flexible packaging material.

25. The flexible packaging material according to claim 1, wherein the pattern is repeated along the width of the flexible packaging material.

26. The flexible packaging material according to claim 1, wherein the pattern is repeated along the length and the width of the flexible packaging material.

27. The package according to claim 14, wherein the pattern is repeated along the length of the packaging material.

28. The package according to claim 14, wherein the pattern is repeated along the width of the packaging material.

29. The package according to claim 14, wherein the pattern is repeated along the length and the width of the packaging material.
